(19) United States
(12) Patent Application Publication
(10) Pub. No.: US 2011/0154502 A1
(43) Pub. Date: Jun. 23, 2011

(54) Data Protection

(76) Inventors: Gyan Prakash, Beaverton, OR (US); Sanjay Bakshi, Beaverton, OR (US); Duncan Glendinning, Chandler, AZ (US); Saurabh Dadu, Tigard, OR (US)

(21) Appl. No.: 12/653,802

(22) Filed: Dec. 18, 2009

(51) Int. Cl. G06F 21/00; G06F 21/24

(52) U.S. Cl. 726/26

(57) ABSTRACT

A method to manage data access in an electronic device comprising a housing having a lid comprises receiving, from a remote server, a data protection policy, storing the data protection policy in a memory location on the electronic device, detecting a transition from a lid open status to a lid closed status, and in response to the transition, implementing the data protection policy on the electronic device. Other embodiments may be described.

### RELATED APPLICATIONS

None.

### BACKGROUND

The subject matter described herein relates generally to the field of electronic devices and more particularly to data protection in electronic devices.

Some electronic devices may be susceptible to data loss due to theft of the electronic device. This problem is exacerbated in mobile computing devices which include a power management system such as the Advanced Configuration and Power Interface (ACPI) system because users frequently choose simply to close the lid on their device rather than to completely shut down the device. Thus, when an electronic device is stolen the data is accessible to the thief when the lid is opened, which restarts the system.

In some instances the data resident on the device is confidential, and may be far more valuable than the electronic device. Accordingly techniques to safeguard data in the event that an electronic device is stolen or is subject to an unauthorized access by a user may find utility.

### BRIEF DESCRIPTION OF THE DRAWINGS

The detailed description is described with reference to the accompanying figures.

FIG. 1 is a schematic illustration of an exemplary system which may be adapted to implement data protection in accordance with some embodiments.

FIG. 2 is a schematic illustration of an exemplary networking environment in which a system may be adapted to implement data protection in accordance with some embodiments.

FIG. 3 is a flowchart illustrating operations in a method to implement data protection in an electronic device, in accordance with some embodiments.

FIG. 4 is a flowchart illustrating operations in a method to implement data protection in an electronic device, in accordance with some embodiments.

FIG. 5 is a schematic illustration of a system which may be adapted to implement data protection, according to an embodiment.

### DETAILED DESCRIPTION

Described herein are exemplary systems and methods for to implement data protection in electronic devices. In the following description, numerous specific details are set forth to provide a thorough understanding of various embodiments. However, it will be understood by those skilled in the art that the various embodiments may be practiced without the specific details. In other instances, well-known methods, procedures, components, and circuits have not been illustrated or described in detail so as not to obscure the particular embodiments.

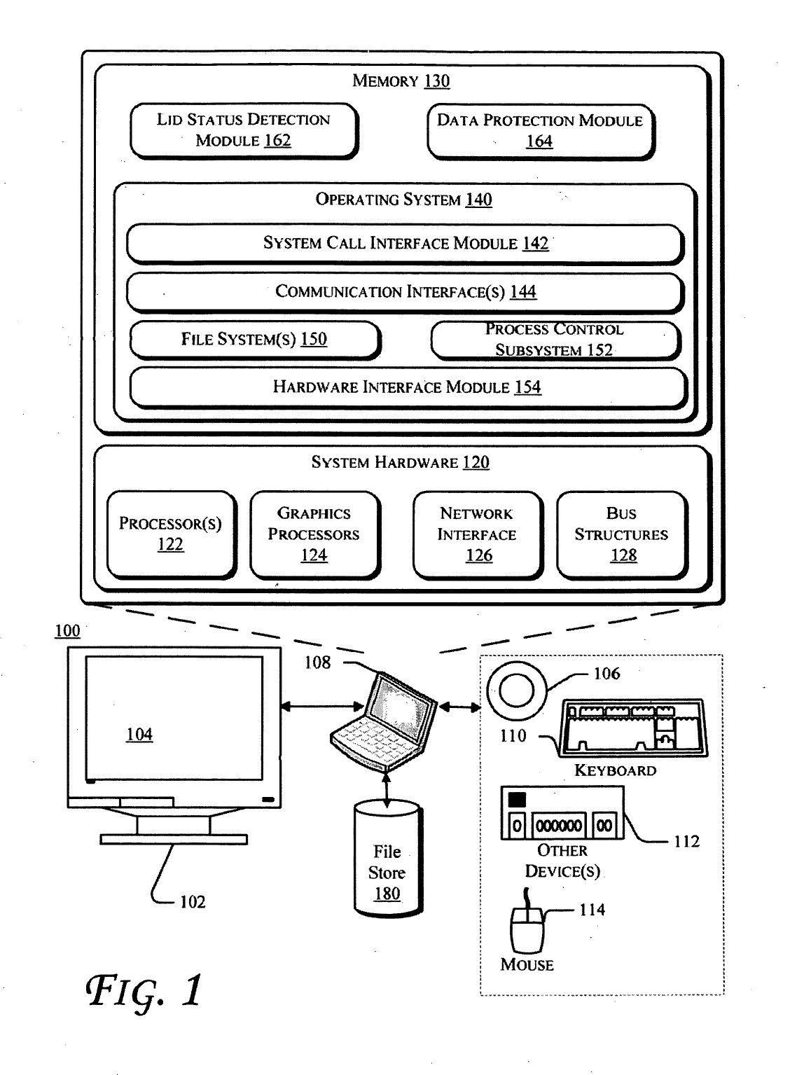

FIG. 1 is a schematic illustration of an exemplary system which may be adapted to implement data protection in accordance with some embodiments. In one embodiment, system 100 includes an electronic device 108 and one or more accompanying input/output devices including a display 102 having a screen 104, one or more speakers 106, a keyboard 110, one or more other I/O device(s) 112, and a mouse 114. The other I/O device(s) 112 may include a touch screen, a voice-activated input device, a track ball, and any other device that allows the system 100 to receive input from a user.

In various embodiments, the electronic device 108 may be embodied as a personal computer, a laptop computer, a personal digital assistant, a mobile telephone, an entertainment device, or another computing device. In one embodiment, the computing device further comprises a housing having a lid 107.

The electronic device 108 includes system hardware 120 and memory 130, which may be implemented as random access memory and/or read-only memory. A file store 180 may be communicatively coupled to computing device 108. File store 180 may be internal to computing device 108 such as, e.g., one or more hard drives, CD-ROM drives, DVD-ROM drives, or other types of storage devices. File store 180 may also be external to computer 108 such as, e.g., one or more external hard drives, network attached storage, or a separate storage network.

System hardware 120 may include one or more processors 122, at least two graphics processors 124, network interfaces 126, and bus structures 128. In one embodiment, processor 122 may be embodied as an Intel® Core2 Duo® processor available from Intel Corporation, Santa Clara, Calif., USA. As used herein, the term “processor” means any type of computational element, such as but not limited to, a microprocessor, a microcontroller, a complex instruction set computing (CISC) microprocessor, a reduced instruction set (RISC) microprocessor, a very long instruction word (VLIW) microprocessor, or any other type of processor or processing circuit.

In some embodiments one of the processors 122 in system hardware 120 may comprise a low-power embedded processor, referred to herein as a manageability engine (ME). The manageability engine 122 may be implemented as an independent integrated circuit or may be a dedicated portion of a larger processor 122.

Graphics processor(s) 124 may function as adjunct processor that manages graphics and/or video operations. Graphics processor(s) 124 may be integrated onto the motherboard of computing system 100 or may be coupled via an expansion slot on the motherboard.

In one embodiment, network interface 126 could be a wired interface such as an Ethernet interface (see, e.g., Institute of Electrical and Electronics Engineers/IEEE 802.3-2002) or a wireless interface such as an IEEE 802.11a, b or g-compliant interface (see, e.g., IEEE Standard for IT-Telecommunications and information exchange between systems LAN/MAN—Part II: Wireless LAN Medium Access Control (MAC) and Physical Layer (PHY) specifications Amendment 4: Further Higher Data Rate Extension in the 2.4 GHz Band, 802.11G-2003). Another example of a wireless interface would be a general packet radio service (GPRS) interface (see, e.g., Guidelines on GPRS Handset Requirements, Global System for Mobile Communications/GSM Association, Ver. 3.0.1, December 2002).

Bus structures 128 connect various components of system hardware 128. In one embodiment, bus structures 128 may be one or more of several types of bus structure(s) including a memory bus, a peripheral bus or external bus, and/or a local bus using any variety of available bus architectures including, but not limited to, 11-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

Memory 130 may include an operating system 140 for managing operations of computing device 108. In one embodiment, operating system 140 includes a hardware interface module 154 that provides an interface to system hardware 120. In addition, operating system 140 may include a file system 150 that manages files used in the operation of computing device 108 and a process control subsystem 152 that manages processes executing on computing device 108.

Operating system 140 may include (or manage) one or more communication interfaces that may operate in conjunction with system hardware 120 to transceive data packets and/or data streams from a remote source. Operating system 140 may further include a system call interface module 142 that provides an interface between the operating system 140 and one or more application modules resident in memory 130. Operating system 140 may be embodied as a UNIX operating system or any derivative thereof (e.g., Linux, Solaris, etc.) or as a

In one embodiment, memory 130 includes a lid status detection module 162 to monitor the status of the lid 107 on computing device 108. Memory 130 further comprises a data protection module 164 to implement one or more data protection policies. In one embodiment, the lid status detection module 162 and the data protection module 164 may be embodied as logic instructions stored in the computer readable memory module 130 of the system 100. In other embodiments the lid status detection module 162 and the data protection module 164 may be reduced to firmware which may be stored with a basic input/output system (BIOS) for the system 100, or to hardwired logic circuitry, e.g., an integrated circuit (IC). Additional details about the operations implemented by graphics processor selection module are described below.

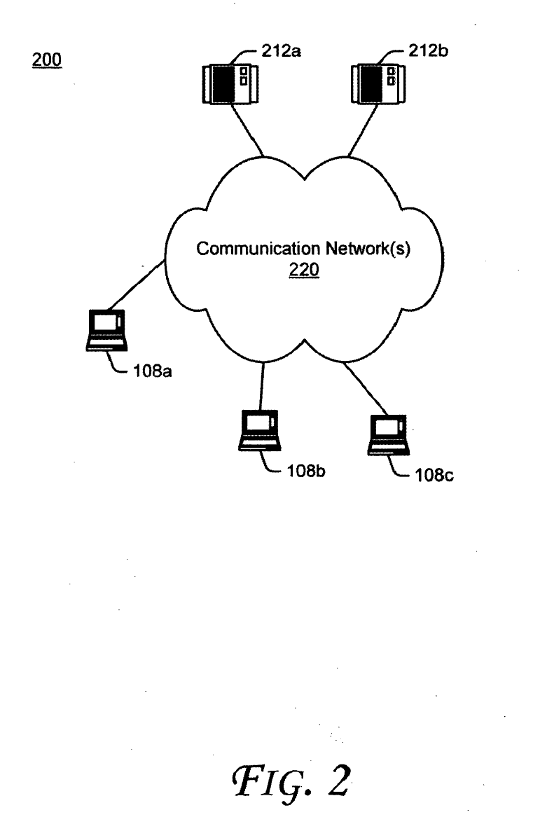

FIG. 2 is a schematic illustration of an exemplary networking environment in which a system may be adapted to implement data protection in accordance with some embodiments. Networking environment 200 may comprise a one or more electronic devices 108a, 108b, 108c, (referred to generally by 108) connected to one or more servers 212a, 212b, (referred to generally by 212) by a communication network 220.

Electronic devices 108 may be implemented as computing devices such as, e.g., a networked computer, a laptop computer, a desktop computer, an electronic device as described with reference to the electronic device 108 in FIG. 1. Applications running on electronic devices 108 may initiate service requests to resources provided by servers 212 via communication network(s) 220. The communication network(s) 220 may be implemented as a Personal Area Network (PAN), Local Area Network (LAN), Metropolitan Area Network (MAN) or a Wide Area Network (WAN) or the like. Furthermore, communication network 220 may comprise one or more sub-networks. By way of example, and not by limitation, communication network 150 may comprise one or more wireless access points (WAPs) that establish a wireless network, which is coupled to a LAN or directly to a backbone network such as the Internet. Additionally, the communication network 220 may include a variety of input/output transports such as, but not limited to; wired USB or serial links, Wireless 802.11x link, wireless USB, Blue-tooth, infra red link or the like.

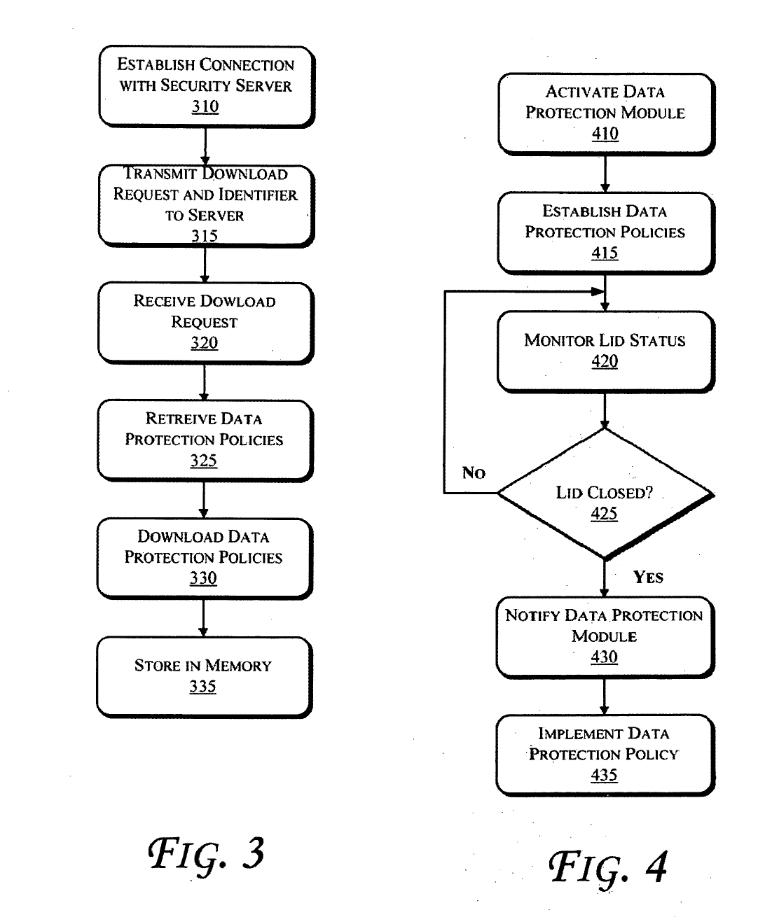

In some embodiments one or more of the servers 212 provides a data protection configuration service to one or more electronic devices 108. Operations for implementing a data protection service are described with reference to FIG. 3 and FIG. 4.

Referring first to FIG. 3, in some embodiments the electronic device 108 receives one or more data protection policies from one of the servers 212. Thus, at operation 310 the electronic device 108 establishes a connection with a server 212 via communication network 220. In some embodiments the connection may be initiated by the electronic device 108, e.g., by the manageability engine or by the basic input/output system (BIOS), when the electronic device 108 is operated. At operation 315 the electronic device 108 transmits a download request to the server 212. In some embodiments the download request comprises an identifier associated with the electronic device 108. The identifier may uniquely identify the device 108, or may identify an organization with which the electronic device 108 is associated. For example, the identifier may identify the organization that owns the electronic device 108.

At operation 320 the server 212 receives the download request via the communication network 220, and at operation 325 the server retrieves one or more data protection policies for the device. In some embodiments the server may maintain one or more data protection polices, which may be associated with device identifiers. The data protection policies may be stored in a computer-readable medium, e.g., a database or a flat file, which may be searched using the identifier received with the request.

At operation 330 the server 212 downloads the data protection policy(ies) to the electronic device 108, which stores the policy(ies) in memory at operation 335. In some embodiments the data protection policy(ies) may be stored in memory as a data protection module 164. For example, the data protection policies may be embodied as logic instructions which may be executed on a processor, e.g., software or firmware. The data protection module 164 may override any data protection settings established by the user of the device.

Once the data protection policies are resident on the electronic device, the electronic device may use the data protection policies to manage data protection on the electronic device. FIG. 4 is a flowchart illustrating operations in a method to implement data protection in an electronic device, in accordance with some embodiments. Referring to FIG. 4, at operation 410 the data protection module 164 in the electronic device 108 is activated. In a network-based embodiment as depicted in FIG. 2, an electronic device 108 may initiate a request to the server 212 to activate the data protection module 164. In some embodiments the data protection module 212 may be activated automatically when the electronic device 108 is powered-up, e.g., by the basic input/output system (BIOS) of the device. At operation 415 the data protection module 164 establishes one or more data protection policies for the electronic device 108.

At operation 420 the lid status detection module 162 monitors the status of the lid 107 on the electronic device 108. In some embodiments the lid status detection module monitors a lid status parameter in an ACPI table managed by the BIOS or Embedded Controller/Keyboard Controller of the electronic device. By way of example, some electronic devices such as laptop computers comprise a mechanical lid switch, the status of which may be monitored by ACPI or by checking the status a general purpose input/output (GPIO) pin signal coupled to the mechanical switch.

If, at operation 425, the lid 107 is not in a closed position then the lid status detection module 162 continues to monitor the lid status while the electronic device 108 is free to continue normal operations. By contrast, if at operation 425 the lid is in the closed position then control passes to operation 430 and the lid status detection module 162 notifies the data protection module 164 that the lid 107 has been closed.

In response, at operation 435 the data protection module 164 implements one or more data protection policies in accordance with the policies adopted during the configuration process. By way of example, and not limitation, the data protection policies may include one or more of the following policies.

In one embodiment the data protection module 164 may force the electronic device 108 into a sleep state or a hibernate state from which a password protected login is required to revive the electronic device 108 back into an operating state. By way of example, in an electronic device that implements an ACPI power management system the data protection module 164 may generate an interrupt to system firmware which forces the system into an S3 or an S4 state. Alternatively, or in addition, the data protection module 164 may disable one or more access ports for the electronic device 108. By way of example, the data protection module 164 may disable one or more universal serial bus (USB) ports and/or one or more network connection ports in the electronic device 108. One skilled in the art will recognize that additional data protection measures may be implemented.

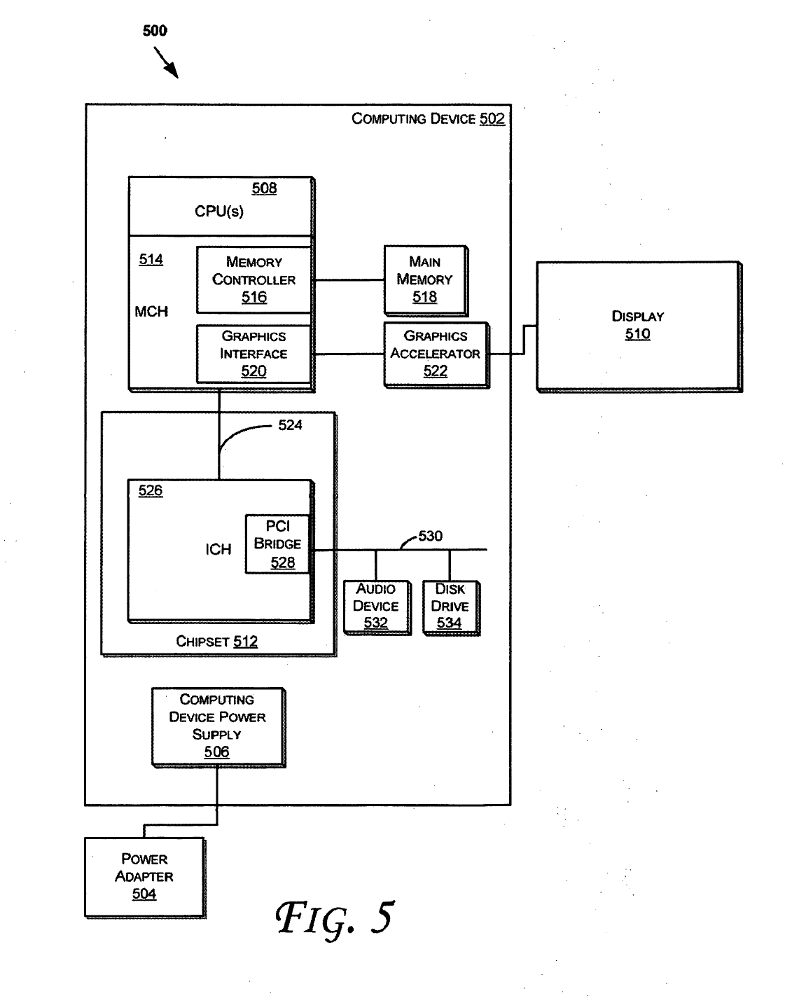

As described above, in some embodiments the electronic device may be embodied as a computer system. FIG. 5 is a schematic illustration of a computer system 500 in accordance with some embodiments. The computer system 500 includes a computing device 502 and a power adapter 504 (e.g., to supply electrical power to the computing device 502). The computing device 502 may be any suitable computing device such as a laptop (or notebook) computer, a personal digital assistant, a desktop computing device (e.g., a workstation or a desktop computer), a rack-mounted computing device, and the like.

Electrical power may be provided to various components of the computing device 502 (e.g., through a computing device power supply 506) from one or more of the following sources: one or more battery packs, an alternating current (AC) outlet (e.g., through a transformer and/or adaptor such as a power adapter 504), automotive power supplies, airplane power supplies, and the like. In some embodiments, the power adapter 504 may transform the power supply source output (e.g., the AC outlet voltage of about 110VAC to 240VAC) to a direct current (DC) voltage ranging between about 7VDC to 12.6VDC. Accordingly, the power adapter 504 may be an AC/DC adapter.

The computing device 502 may also include one or more central processing unit(s) (CPUs) 508. In some embodiments, the CPU 508 may be one or more processors in the Pentium® family of processors including the Pentium® II processor family, Pentium® III processors, Pentium® IV, or CORE2 Duo processors available from Intel® Corporation of Santa Clara, Calif. Alternatively, other CPUs may be used, such as Intel's Itanium®, XEON™, and Celeron® processors. Also, one or more processors from other manufactures may be utilized. Moreover, the processors may have a single or multi core design.

A chipset 512 may be coupled to, or integrated with, CPU 508. The chipset 512 may include a memory control hub (MCH) 514. The MCH 514 may include a memory controller 516 that is coupled to a main system memory 518. The main system memory 518 stores data and sequences of instructions that are executed by the CPU 508, or any other device included in the system 500. In some embodiments, the main system memory 518 includes random access memory (RAM); however, the main system memory 518 may be implemented using other memory types such as dynamic RAM (DRAM), synchronous DRAM (SDRAM), and the like. Additional devices may also be coupled to the bus 510, such as multiple CPUs and/or multiple system memories.

The MCH 514 may also include a graphics interface 520 coupled to a graphics accelerator 522. In some embodiments, the graphics interface 520 is coupled to the graphics accelerator 522 via an accelerated graphics port (AGP). In some embodiments, a display (such as a flat panel display) 540 may be coupled to the graphics interface 520 through, for example, a signal converter that translates a digital representation of an image stored in a storage device such as video memory or system memory into display signals that are interpreted and displayed by the display. The display 540 signals produced by the display device may pass through various control devices before being interpreted by and subsequently displayed on the display.

A hub interface 524 couples the MCH 514 to an platform control hub (PCH) 526. The PCH 526 provides an interface to input/output (I/O) devices coupled to the computer system 500. The PCH 526 may be coupled to a peripheral component interconnect (PCI) bus. Hence, the PCH 526 includes a PCI bridge 528 that provides an interface to a PCI bus 530. The PCI bridge 528 provides a data path between the CPU 508 and peripheral devices. Additionally, other types of I/O interconnect topologies may be utilized such as the PCI Express™ architecture, available through Intel® Corporation of Santa Clara, Calif.

The PCI bus 530 may be coupled to an audio device 532 and one or more disk drive(s) 534. Other devices may be coupled to the PCI bus 530. In addition, the CPU 508 and the MCH 514 may be combined to form a single chip. Furthermore, the graphics accelerator 522 may be included within the MCH 514 in other embodiments.

Additionally, other peripherals coupled to the PCH 526 may include, in various embodiments, integrated drive electronics (IDE) or small computer system interface (SCSI) hard drive(s), universal serial bus (USB) port(s), a keyboard, a mouse, parallel port(s), serial port(s), floppy disk drive(s), digital output support (e.g., digital video interface (DVI)), and the like. Hence, the computing device 502 may include volatile and/or nonvolatile memory.

The terms “logic instructions” as referred to herein relates to expressions which may be understood by one or more machines for performing one or more logical operations. For example, logic instructions may comprise instructions which are interpretable by a processor compiler for executing one or more operations on one or more data objects. However, this is merely an example of machine-readable instructions and embodiments are not limited in this respect.

The terms “computer readable medium” as referred to herein relates to media capable of maintaining expressions which are perceivable by one or more machines. For example, a computer readable medium may comprise one or more storage devices for storing computer readable instructions or data. Such storage devices may comprise storage media such as, for example, optical, magnetic or semiconductor storage media. However, this is merely an example of a computer readable medium and embodiments are not limited in this respect.

The term “logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments are not limited in this respect.

Some of the methods described herein may be embodied as logic instructions on a computer-readable medium. When executed on a processor, the logic instructions cause a processor to be programmed as a special-purpose machine that implements the described methods. The processor, when configured by the logic instructions to execute the methods described herein, constitutes structure for performing the described methods. Alternatively, the methods described herein may be reduced to logic on, e.g., a field programmable gate array (FPGA), an application specific integrated circuit (ASIC) or the like.

In the description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

Reference in the specification to “one embodiment” or “some embodiments” means that a particular feature, structure, or characteristic described in connection with the embodiment is included in at least an implementation. The appearances of the phrase “in one embodiment” in various places in the specification may or may not be all referring to the same embodiment.

Although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method to manage data access in an electronic device comprising a housing having a lid, comprising:
receiving, from a remote server, a data protection policy;
storing the data protection policy in a memory location on the electronic device;
detecting a transition from a lid open status to a lid closed status; and
in response to the transition, implementing the data protection policy on the electronic device.

2. The method of claim 1, wherein detecting a transition from a lid open status to a lid closed status comprises at least one of:
detecting a lid status parameter in an Advanced Configuration and Power Interface (ACPI) table; and
detecting a status of a General Purpose Input/Output (GPIO) signal.

3. The method of claim 1, wherein implementing a data protection policy comprises at least one of:
forcing the electronic device into a sleep state or a hibernate state;
disabling one or more access ports;
disabling one or more network connections;
forcing a login procedure;
encrypting data stored on the electronic device; or
decrypting data stored on the electronic device when the login procedure is successful.

4. The method of claim 1, wherein implementing a data protection policy comprises overriding a data protection policy set by a user of the computer system.

5. The method of claim 1, wherein further comprising:
reactivating the computer system when the lid is reopened and requirements of the data protection policy are satisfied.

6. A computer program product comprising logic instructions stored on a computer readable medium which, when executed by a processor in an electronic device, configure the processor to manage data access in an electronic device comprising a housing having a lid by performing operations, comprising:
receiving, from a remote server, a data protection policy;
storing the data protection policy in a memory location on the electronic device;
detecting a transition from a lid open status to a lid closed status;
in response to the transition, implementing the data protection policy on the electronic device.

7. The computer program product of claim 6, wherein detecting a transition from a lid open status to a lid closed status comprises at least one of:
detecting a lid status parameter in an Advanced Configuration and Power Interface (ACPI) table; and
detecting a status of a General Purpose Input/Output (GPIO) signal.

8. The computer program product of claim 6, wherein implementing a data protection policy comprises at least one of:
forcing the electronic device into a sleep state or a hibernate state;
disabling one or more access ports;
disabling one or more network connections;
forcing a login procedure;
encrypting data stored on the electronic device; or
decrypting data stored on the electronic device when the login procedure is successful.

9. The computer program product of claim 6, wherein implementing a data protection policy comprises overriding a data protection policy set by a user of the computer system.

10. The computer program product of claim 6, wherein further comprising:
reactivating the computer system when the lid is reopened and requirements of the data protection policy are satisfied.

11. A method to manage data access in one or more electronic devices comprising a housing having a lid, comprising:
receiving, in a server, a request from an electronic device for a data protection policy, wherein the request includes an identifier associated with the electronic device;
retrieving, in the server, at least one data protection policy associated with the identifier; and
transmitting the at least one data protection policy to the electronic device.

12. The method of claim 11, further comprising:
storing the data protection policy in a memory location on the electronic device;
detecting a transition from a lid open status to a lid closed status;
in response to the transition, implementing the data protection policy on the electronic device.

13. The method of claim 11, wherein detecting a transition from a lid open status to a lid closed status comprises at least one of:
detecting a lid status parameter in an Advanced Configuration and Power Interface (ACPI) table; and
detecting a status of a General Purpose Input/Output (GPIO) signal.

14. The method of claim 11, wherein implementing a data protection policy comprises at least one of forcing the electronic device into a sleep state or a hibernate state;
disabling one or more access ports;
disabling one or more network connections;
forcing a login procedure;
encrypting data stored on the electronic device; or
decrypting data stored on the electronic device when the login procedure is successful.

15. The method of claim 11, wherein implementing a data protection policy comprises overriding, a data protection policy set by a user of the computer system.

16. The method of claim 11, wherein further comprising:
reactivating the computer system when the lid is reopened and requirements of the data protection policy are satisfied.

17. A computer program product comprising logic instructions stored on a computer readable medium which, when executed by a processor in an electronic device, configure the processor to manage data access in one or more electronic devices comprising a housing having a lid by performing operations, comprising:
receiving, in a server, a request from an electronic device for a data protection policy, wherein the request includes an identifier associated with the electronic device;
retrieving, in the server, at least one data protection policy associated with the identifier; and
transmitting the at least one data protection policy to the electronic device.

18. The computer program product of claim 17, further comprising:
storing the data protection policy in a memory location on the electronic device;
detecting a transition from a lid open status to a lid closed status;
in response to the transition, implementing the data protection policy on the electronic device.

19. The computer program product of claim 17, wherein detecting a transition from a lid open status to a lid closed status comprises at least one of:
detecting a lid status parameter in an Advanced Configuration and Power Interface (ACPI) table; and
detecting a status of a General Purpose Input/Output (GPIO) signal.

20. The computer program product of claim 17, wherein implementing a data protection policy comprises at least one of:
forcing the electronic device into a sleep state or a hibernate state;
disabling one or more access ports;
disabling one or more network connections;
forcing a login procedure;
encrypting data stored on the electronic device; or
decrypting data stored on the electronic device when the login procedure is successful.

21. The computer program product of claim 17, wherein implementing a data protection policy comprises overriding a data protection policy set by a user of the computer system.

22. The computer program product of claim 17, wherein further comprising:
reactivating the computer system when the lid is reopened and requirements of the data protection policy are satisfied.
